(19) United States
(12) Patent Application Publication
(10) Pub. No.: US 2018/0073113 A1
(43) Pub. Date: Mar. 15, 2018

(54) CASE-HARDENABLE STAINLESS STEEL ALLOY

(71) Applicants: Aktiebolaget SKF, Goteborg (SE); SKF Aerospace France S.A.S, Saint-Vallier (FR)

(72) Inventors: Mohamed Sherif, Hilversum (NL); John Beswick, Montfoort (NL); Staffan Larsson, Goteborg (SE); Yves Maheo, Anneyron (FR)

(21) Appl. No.: 15/695,648

(22) Filed: Sep. 5, 2017

(30) Foreign Application Priority Data
Sep. 13, 2016 (GB) 1615519.4

(51) Int. Cl. C22C 38/52; F16C 33/62; F16C 33/64; C22C 38/46; C22C 38/44; C22C 38/04; C22C 38/02; C22C 38/48; C23C 8/22; C21D 1/06; C21D 9/40

(52) U.S. Cl. CPC C22C 38/52; C21D 2211/001; F16C 33/64; C22C 38/46; C22C 38/44; C22C 38/04; C22C 38/02; C22C 38/48; C23C 8/22; C21D 1/06; C21D 9/40; F16C 2204/62; F16C 2206/40; F16C 2204/72; F16C 33/62

(57) ABSTRACT

A steel alloy for a bearing, the alloy having a composition having from 0.04 to 0.1 wt. % carbon, from 10.5 to 13 wt. % chromium, from 1.5 to 3.75 wt. % molybdenum, from 0.3 to 1.2 wt. % vanadium, from 0.3 to 2.0 wt .% nickel, from 6 to 9 wt. % cobalt, from 0.05 to 0.4 wt. % silicon, from 0.2 to 0.8 wt. % manganese, from 0.02 to 0.06 wt. % niobium, from 0 to 2.5 wt. % copper, from 0 to 0.1 wt. % aluminium, from 0 to 250 ppm nitrogen, from 0 to 30 ppm boron, and the balance iron, together with any unavoidable impurities.

### CROSS REFERENCE TO RELATED APPLICATIONS

This application claims priority to British patent application no. 1615519.4 filed on Sep. 13, 2016, the contents of which are fully incorporated herein by reference.

### FIELD OF THE INVENTION

The present invention relates generally to the field of metallurgy. More specifically, the present invention relates to a stainless steel alloy for use in the manufacture of case-hardened bearing components, especially for hybrid bearings used in aerospace applications.

### BACKGROUND OF THE INVENTION

Bearings for aerospace applications are typically required to operate under high loads and extreme temperatures in an environment that may be exposed to moisture. Such components therefore need to possess an optimal combination of toughness, high-temperature capability and corrosion resistance, in addition to excellent case hardness and core ductility.

Stainless steels are known and typically contain a minimum of 10.1% Cr to achieve the desired corrosion resistance. For example, Pyrowear® 675 stainless is a carburising, corrosion-resistant steel designed to provide a case hardness in excess of HRC 60 combined with a tough, ductile core. Pyrowear® 675 stainless has been used in bearing and gearing type applications. Pyrowear® 675 stainless contains approximately 0.07 wt. % C and 13 wt. % Cr as well as Mo, V, Ni, Co, Si and Mn and Fe.

Furthermore, an example of a case-hardenable corrosion-resistant alloy used for aircraft bearings is disclosed in EP0411931.

Typically, bearings manufactured using such alloys are all-steel bearings; that is, the bearing rings and the rolling elements are made of steel. A hybrid bearing is a bearing which has steel bearing rings and ceramic rolling elements. The use of ceramic rolling elements increases the load-carrying capacity of a bearing, but in order to fully utilize the load capacity of the ceramic rolling elements, the steel surfaces of the bearing rings need to be stronger than is currently achievable using available case-hardenable alloys.

Furthermore, the use of lubricants comprising aggressive chemicals is placing stricter requirements on corrosion resistance, particularly standstill corrosion resistance.

It is thus an object of the present invention to define a stainless steel alloy for use in the manufacture of case-hardened bearing components, which results in high surface strength in combination with excellent core toughness and corrosion resistance.

### BRIEF SUMMARY OF THE INVENTION

The present invention provides a stainless steel alloy for a bearing, the alloy having a composition comprising:

from 0.04 to 0.1 wt. % carbon,

from 10.5 to 13.0 wt. % chromium,

from 1.5 to 3.75 wt. % molybdenum,

from 0.3 to 1.2 wt. % vanadium,

from 0.3 to 2.0 wt. % nickel,

from 6.0 to 9.0 wt. % cobalt,

from 0.05 to 0.4 wt. % silicon,

from 0.2 to 0.8 wt. % manganese,

from 0.02 to 0.06 wt. % niobium,

from 0 to 2.5 wt. % copper,

from 0 to 0.1 wt. % aluminium,

from 0 to 250 ppm nitrogen,

from 0 to 30 ppm boron, and the balance iron, together with any unavoidable impurities.

In a further aspect, a method of producing a machine component is provided. The method comprises steps of forming the bearing component from the inventive steel alloy and case-hardening a surface of the bearing component.

The steel alloy itself may be formed using a processing route that is selected from: vacuum induction melting (VIM); vacuum arc remelting (VAR); electroslag remelting (ESR) or a combination thereof. Powder metallurgy (PM) processing is also possible. The powder metallurgical route would typically require the application of hot isostatic pressing (HIP) of the metal powder for optimal density. The HIP process may be preceded by cold isostatic pressing (CIP).

The step of case-hardening is conducted by diffusing carbon (carburisation), nitrogen (nitriding), carbon and nitrogen (carbonitriding) and/or boron (boriding) into the outer layer of the steel at an elevated temperature. These are therefore thermochemical processes. They are typically followed by a further heat-treatment to achieve the desired hardness profile and desired properties in the case and in the core.

In one embodiment, the method comprises case-carburising. Vacuum carburising, gas carburising, liquid carburising or solid (pack) carburising may be applied. Each of these processes relies on the transformation of austenite into martensite on quenching. The increase in carbon content at the surface must be high enough to give a martensitic layer with sufficient hardness, typically approximately 750 HV, to provide a wear-resistant surface. The required carbon content at the surface after diffusion is typically 0.8 to 1.2 wt. %.

In a further embodiment, the method comprises carbonitriding. A nitrogen source such as ammonia may be introduced into the furnace atmosphere during carburising. The inclusion of ammonia can be applied through both low pressure carburising and gas carburising.

Carbonitriding, when applied to a component that is made from a steel alloy according to the invention, has a number of advantages:
Total process time is shortened.
Better corrosion resistance of bearing components is achieved, especially during standstill in humid environments, due to the nitrogen element being in solid solution in the hardened case.

In a further embodiment, the step of case hardening comprises both carburization and carbonitriding. This embodiment is advantageous for components which require a relatively large case depth.

The case-hardened steel alloy exhibits high hardness, excellent corrosion resistance and/or dimensional stability. This means that the steel alloy can usefully find application in the manufacture of, for example, a bearing component such as a rolling element or an inner or outer ring of the bearing. Thus, according to another aspect of the present invention, there is provided a bearing component, comprising a steel alloy as herein described. The present invention also provides a bearing comprising a bearing component as herein described. In a preferred embodiment, the bearing is a hybrid bearing and comprises bearing rings that are manufactured according to the method of the invention and further comprises one or more rolling elements made from a ceramic material.

The present invention will now be described further. In the following passages different aspects of the invention are defined in more detail. Each aspect so defined may be combined with any other aspect or aspects unless clearly indicated to the contrary. In particular, any feature indicated as being preferred or advantageous may be combined with any other feature or features indicated as being preferred or advantageous.

In the present invention, the steel alloy composition comprises from 0.04 to 0.1 wt. % C, preferably from 0.05 to 0.09 wt. % C, more preferably from 0.06 to 0.08 wt. % C, still more preferably approximately 0.07 wt. % C. In combination with the other alloying elements, this results in the desired microstructure (e.g. as-quenched martensite matrix) and mechanical properties conducive to bearing applications. The steel alloy is adapted for case-hardening, whereby the case is enriched with carbon. While a C content higher than about 0.1 wt. % may improve the strength, it is undesirable in that it depresses the martensite start temperature (Ms) of the core austenite upon quenching during hardening. The high martensite start temperature of the core, relative to that of the case, ensures obtaining a good compressive residual stress profile within the bearing component. For this reason, the C content is chosen to be ≦0.1 wt. %, preferably ≦0.09 wt. %, more preferably ≦0.08 wt. %.

The steel composition comprises from 10.5 to 13.0 wt. % Cr, preferably from 10.7 to 12.7 wt. % Cr, more preferably from 10.7 to 12.5 wt. % Cr, still more preferably from 11.0 to 12.5 wt. % Cr. Chromium is known to be beneficial in terms of corrosion resistance and a stainless steel must contain a minimum amount of Cr. Therefore, the minimum Cr content is set at 10.5 wt. %. The Cr content (in conjunction with the other alloying elements, particularly the Mo) is preferably chosen to minimise the occurrence of an undesirable high temperature ferrite phase (δ-ferrite) in the core, while maximising the PREN number (see below). Cr is a ferrite stabiliser and, therefore, the content thereof is preferably such that the undesirable δ-ferrite phase in the core is not formed during heat treatment. The δ-ferrite phase, if present in the core, may cause an appreciable increase in the austenite carbon content, which in turn lowers the martensite start temperature. In addition, poor mechanical properties are expected when δ-ferrite is present in the core in significant quantities. For these reasons, the Cr content is chosen to be ≦13 wt. %, preferably ≦12.7 wt. %, more preferably ≦12.5 wt. %.

The steel composition comprises from 1.5 to 3.75 wt. % Mo. Mo may act to avoid austenite grain boundary embrittlement owing to impurities such as, for example, phosphorus. Mo may also act to increase hardenability. Mo has a greater effect than Cr on the PREN number. Accordingly, for a given Cr eq. number, the Mo and Cr contents are preferably balanced to minimise the occurrence of δ-ferrite in the core while, maximising the PREN number. Mo is a ferrite stabiliser and, therefore, the content thereof is preferably such that the δ-ferrite phase in the core is not formed during heat treatment. The δ-ferrite phase, if present in the core, may cause an appreciable increase in the austenite carbon content, which in turn lowers the martensite start temperature. In addition, poor mechanical properties are expected when δ-ferrite is present in the core in significant quantities. For these reasons, the Mo content is chosen to be 1.5 to 3.75 wt. %, preferably 1.65 to 3.6 wt. %.

As noted above, Mo and Cr affect the pitting resistance equivalent number (PREN), which is defined as PREN=Cr %+3.3 Mo %+16 N (elements in wt. %). PREN is a well-known indication of the corrosion resistance of stainless steel in a chloride-containing environment. In general: the higher the PREN value, the more corrosion resistant the steel. In the present invention, the steel alloy composition may preferably have a PREN (core) of 16 to 22, preferably 18.5 to 22, more preferably 19 to 22 wt. %. The upper limit is preferably ≧20, more preferably ≧21, still more preferably ≧21.5, and most preferably about 22.

When carbonitriding case hardening is applied, the increased nitrogen in solid solution in the case will result in a relatively higher PREN. It is thus anticipated that bearing components processed in this way will exhibit improved standstill corrosion resistance, compared with case-carburising only.

The steel composition comprises from 0.3 to 1.2 wt. % V. The addition of V has been found to be beneficial in terms of improved hot-hardness and also control of the microstructure's response during tempering. In addition, V is beneficial in ensuring a fine-grained structure. Too high a V content will lock more carbon in MC-type of carbides, which leads to the as-quenched martensite matrix not exhibiting enough strength and hardness, which are necessary for bearing applications. In addition, V is a ferrite stabiliser, so its content must be balanced with other austenite-stabilising elements. Therefore, in the present invention, the V content is 0.3 to 1.2 wt. %, preferably 0.4 to 1.1 wt. %, more preferably 0.5 to 1.1 wt. %.

The steel composition comprises from 0.3 to 2.0 wt. % Ni. The Ni content is relatively low in the present invention, such that the Co content can be raised (see below). The low carbon content of the core ensures good toughness and the Ni content may be reduced accordingly. Ni is also a relatively expensive alloying element. Therefore, in the present invention, the Ni content is 0.3 to 2.0 wt. %, preferably 0.3 to 1.9 wt. %, more preferably 0.4 to 1.9 wt. %, still more preferably 0.5 to 1.8 wt. %.

The steel composition comprises from 6.0 to 9.0 wt. % Co. Co and Ni both contribute to the Ni eq. and, as such, are preferably balanced. For a given N eq., the lower Ni content enables raising the Co content of the alloy. A higher Co content has been found beneficial in terms of the formation of finer carbides in the structure with benefits in terms of higher hardness and strength. However, too high a Co content may depress the Ms temperature, resulting in difficulties in transforming austenite into martensite on quenching. Therefore, in the present invention, the Co content is 6 to 9 wt. %, preferably 6 to 8 wt. %, more preferably 6.5 to 7.7 wt. %, still more preferably 7 to 7.5 wt. %.

The steel alloy composition comprises from 0.05 to 0.4 wt. % Si, preferably from 0.1 to 0.3 wt. % Si, more preferably from 0.15 to 0.25 wt. % Si. In combination with the other alloying elements, this results in the desired microstructure with a minimum amount of retained austenite. Si improves the tempering resistance of the steel microstructure and for this reason a minimum amount of 0.15 wt. % Si is added. Si may also contribute to the Cr eq, therefore, too high a Si content may result in more likelihood of stabilising the undesirable δ-ferrite phase in the core of the component. In addition, Si may lower the elastic properties of the matrix. For these reasons, the maximum silicon content is 0.4 wt. %, preferably 0.3 wt. %, more preferably 0.25 wt. %.

The steel alloy composition comprises from 0.2 to 0.8 wt. % Mn, preferably 0.3 to 0.7 wt. % Mn, more preferably 0.4 to 0.6 wt. % Mn. The Mn content is at least 0.2 wt. %, since this, in combination with the other alloying elements, helps to achieve the desired microstructure and properties. Mn also acts to improve hardenability. In addition, Mn acts to increase the stability of austenite relative to ferrite. However, Mn levels above about 0.8 wt. % may serve to increase the amount of retained austenite. This may lead to practical metallurgical issues such as stabilising the retained austenite too much, leading to potential problems with the dimensional stability of the bearing components.

The steel composition comprises from 0.02 to 0.06 wt. % Nb. The addition of Nb is advantageous for preventing excessive austenite grain growth during case-carburising or heat treatment. Preferably, the steel alloy of the invention comprises from 0.02 to 0.04 wt. % Nb.

Furthermore, the presence of Niobium facilitates precipitation of vanadium carbides when the steel alloy contains a sufficient amount of Vanadium. In such embodiments, the steel alloy comprises from 0.65 to 1.2 wt. % V. The alloy may then have a microstructure comprising both niobium-rich and vanadium-rich precipitates.

The steel alloy composition may be further defined by the Ni_{eq} and Cr_{eq}. In particular, the Ni_{4q} is defined as Ni+Co+0.5Mn+30C and may typically range from 10 to 11.5, preferably 10.2 to 11.3, more preferably 10.2 to 11.1, still more preferably 10.4 to 11. Similarly, the Cr_{eq} is defined as Cr+2Si+1.5Mo+5V and may typically range from 17.8 to 20, preferably 18 to 19.7, more preferably 18.2 to 19.6, still more preferably 18.5 to 19.4.

As noted above, the steel composition may optionally include one or more of the following elements:

from 0 to 2.5 wt. % copper,

from 0 to 0.1 wt. % aluminium,

from 0 to 250 ppm nitrogen, and

from 0 to 30 ppm boron.

The steel composition may optionally include up to 2.5 wt. % Cu, for example from 0.01 to 0.5 wt. % Cu. Cu increases the alloy hardenability and corrosion resistance. However, its amount must be properly controlled as it is an austenite stabiliser. If present in levels in excess of 0.3 wt. %, the Cu content is tied to that of Ni given that the wt. % ratio of Cu/Ni is preferably approximately 2 (plus or minus 0.2). This ensures that hot-shortness is mitigated.

The addition of copper to the steel composition is perhaps less desirable when considering the VIM-VAR process route, owing to the element's high vapour pressure. However, in embodiments where the steel alloy composition is processed using VIM-ESR, the addition of copper can be made during the ESR process.

The steel composition may optionally include up to 0.1 wt. % Al, for example from 0.005 to 0.05 wt. % Al, preferably from 0.01 to 0.03 wt. % Al. Al may serve as a deoxidizer. However, the use of Al requires stringent steel production controls to ensure cleanliness and this increases the processing costs. Therefore, the steel alloy comprises no more than 0.05 wt. % Al. However, the Al content would need to be reduced to a trace level and preferably kept to an absolute minimum if the alloy is manufactured by a powder metallurgical route or by spray-forming.

In some embodiments, nitrogen may be added such that the steel alloy comprises from 50 to 250 ppm N, preferably from 75 to 150 ppm N. The presence of N may be beneficial for promoting the formation of complex nitrides and/or carbonitrides. In other embodiments, there is no deliberate addition of N. Nevertheless, the alloy may necessarily still comprise at up to 50 ppm N.

If the alloy is manufactured by a VIM-VAR processing route, the Al concentration may be in the range 0.01 to 0.03 wt. %, for example, and the N concentration may be in the range of 30 to 60 ppm. Both elements help in pinning austenite grain boundaries in the form of aluminium nitride precipitates, thus ensuring a finer-grained structure that is beneficial for demanding bearing applications.

The steel composition may optionally include from 0 to 30 ppm B. Boron may be added, for example, when increased hardenability is desired.

It will be appreciated that the steel alloy referred to herein may contain unavoidable impurities, although, in total, these are unlikely to exceed 0.3 wt. % of the composition. Preferably, the alloys contain unavoidable impurities in an amount of not more than 0.1 wt. % of the composition, more preferably not more than 0.05 wt. % of the composition. In particular, the steel composition may also include one or more impurity elements. A non-exhaustive list of impurities includes, for example:

from 0 to 0.025 wt. % phosphorous

from 0 to 0.015 wt. % sulphur

from 0 to 0.04 wt. % arsenic

from 0 to 0.075 wt. % tin

from 0 to 0.075 wt. % antimony

from 0 to 0.01 wt. % tungsten

from 0 to 0.005 wt. % titanium

from 0 to 0.002 wt. % lead

The steel alloy composition preferably comprises little or no S, for example from 0 to 0.015 wt. % S.

The steel alloy composition preferably comprises little or no P, for example from 0 to 0.025 wt. % P.

The steel composition preferably comprises ≦15 ppm O. O may be present as an impurity. The steel composition preferably comprises ≦30 ppm Ti. Ti may be present as an impurity. The steel composition preferably comprises ≦50 ppm Ca. Calcium may be present as an impurity.

The steel alloys according to the present invention may consist essentially of the recited elements. It will therefore be appreciated that in addition to those elements that are mandatory other non-specified elements may be present in the composition provided that the essential characteristics of the composition are not materially affected by their presence.

The steel alloys according to the present invention preferably have a microstructure comprising martensite (typically tempered martensite), (ii) carbides, and/or carbonitrides, and (iii) optionally some retained austenite. A low level of retained austenite is advantageous in that it improves dimensional stability of a bearing component. The microstructure may further comprise nitrides. Also, it is preferable that there is little or none of the undesirable δ-ferrite phase in the microstructure. A level of ≦10%, preferably ≦3% is preferred.

The structure of the steel alloys may be determined by conventional microstructural characterisation techniques such as, for example, optical microscopy, TEM, SEM, AP-FIM, and X-ray diffraction, including combinations of two or more of these techniques.

BRIEF DESCRIPTION OF THE SEVERAL VIEWS OF THE DRAWING

The invention will now be described further, by way of example, with reference to a number of non-limiting embodiments of steel alloys according to the invention, with reference to a suitable heat treatment for the steel alloys; and with reference to the accompanying drawings, in which:

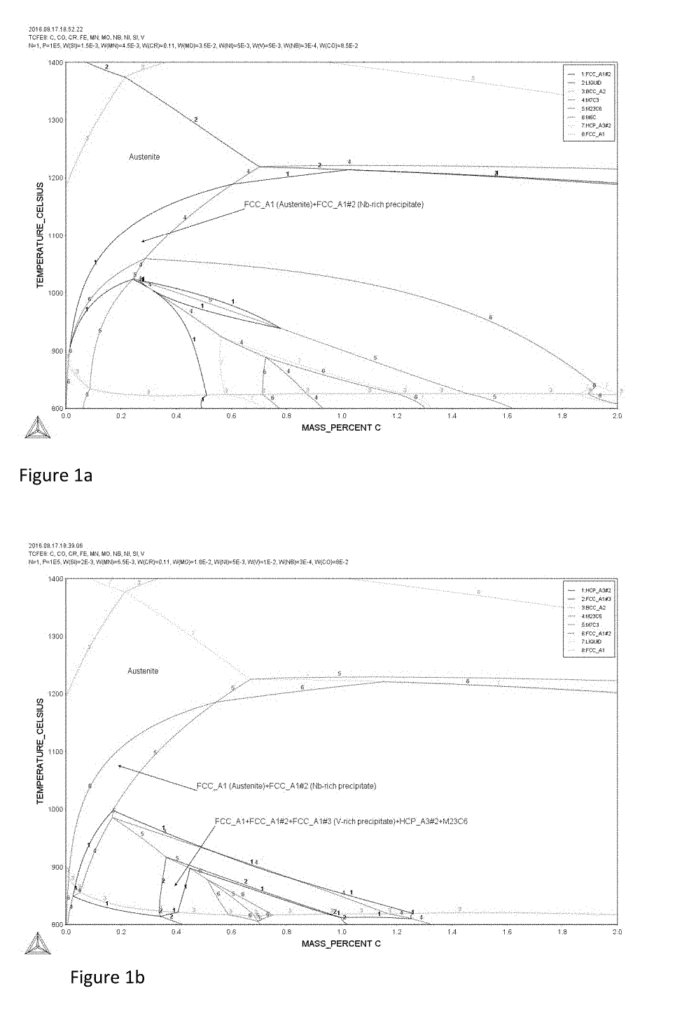

FIG. 1a, 1b respectively show phase diagrams of first and second examples of a steel alloy according to the present invention.

FIG. 1c shows a phase diagram of a comparison steel alloy.

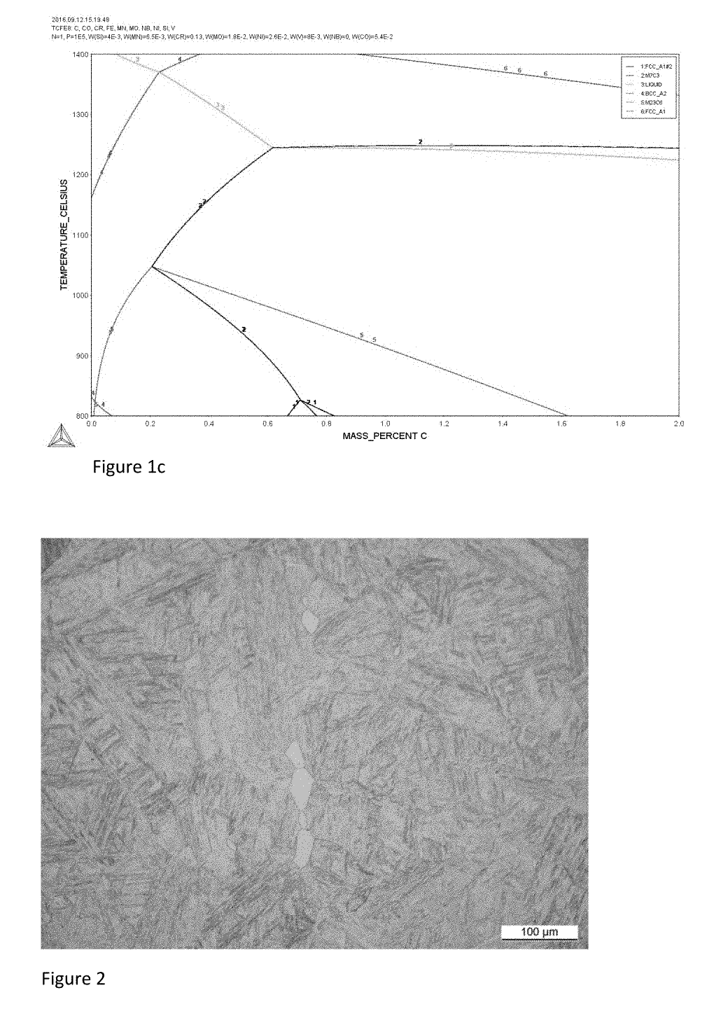

FIG. 2 is a micrograph of the microstructure of a steel alloy according to the present invention (scale indicated).

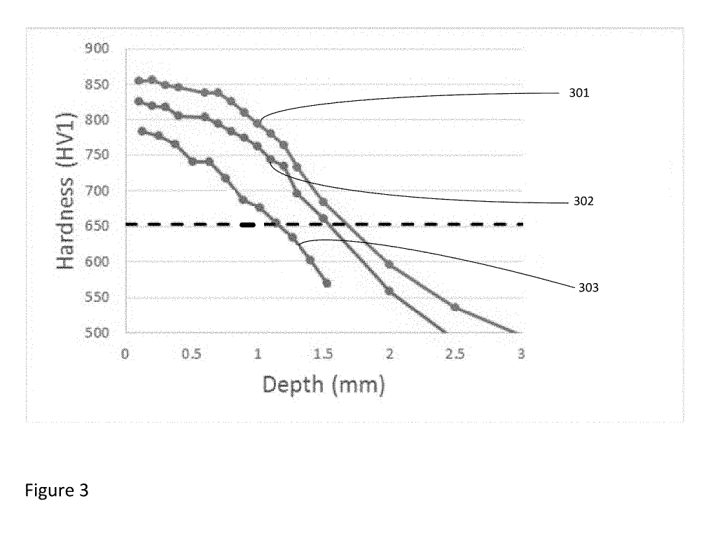

FIG. 3 is a graph depicting the results of a Vickers hardness test performed on samples made from steel alloys according to the invention and on reference samples.

### DETAILED DESCRIPTION OF THE INVENTION

### EXAMPLES

The chemical composition of a number of non-limiting examples of stainless steel alloys according to the invention is given in Table 1.

TABLE 1
The chemical composition of five stainless steels according to the
invention. All quantities are in wt. %. The balance is iron, together
with any unavoidable impurities.

| | Element | | | | | | | | | | | |
|---|---|---|---|---|---|---|---|---|---|---|---|---|
| | | | | | | | | | | Cr | Ni | PRE N |
| | C | Cr | Mo | V | Ni | Co | Si | Mn | Nb | eq. | eq. | core |
| Example | 0.08 | 12.1 | 2.5 | 0.5 | 1.0 | 7.2 | 0.16 | 0.47 | 0.03 | 18.7 | 10.8 | 20.4 |
| 1* | | | | | | | | | | | | |
| Example 2 | 0.07 | 11.0 | 3.5 | 0.5 | 1.0 | 7.25 | 0.15 | 0.45 | 0.04 | 19.1 | 10.6 | 22.6 |
| Example 3 | 0.07 | 12.0 | 2.5 | 0.5 | 1.8 | 6.5 | 0.15 | 0.45 | 0.02 | 18.6 | 10.6 | 20.3 |
| Example 4 | 0.05 | 11.0 | 3.5 | 0.5 | 0.5 | 8.5 | 0.15 | 0.45 | 0.03 | 19.1 | 10.9 | 22.6 |
| Example 5 | 0.07 | 11.0 | 1.8 | 1.0 | 0.5 | 8.0 | 0.2 | 0.65 | 0.03 | 19.0 | 10.9 | 16.9 |

*In Example 1, the alloy further contains 0.026 wt. % Al, 0.02 wt. % N and <0.005 wt. % Cu.

The stainless steels according to the present invention are designed for the manufacture of bearing components, particularly bearing rings, which are subjected to case-hardening. The case hardening may be carried out via carburizing, carbonitriding or a combination of both for larger case depths, preferably at reduced pressure (less than the atmospheric pressure), and usually after a suitable preoxidation step. For example, clean bearing components may be heated in air at 875 to 1050° C. for 1 hour, followed by air cooling. Carburising may be conducted at a temperature in the range of 870 to 950° C. in a carbon-containing medium. Such carburising treatments are conventional in the art and ensure sufficient carbon-enrichment in the carburised case such that there is adequate ΔMs (of the austenite) between the core and the case. This, in turn, ensures the development of a beneficial compressive residual stress profile through the thickness of the bearing component's hardened case and towards the core.

After case-carburising, or carbonitriding, or the combination of both, the bearing components are typically heat-treated and tempered. After the first temper, the parts may be deep-frozen at near liquid nitrogen temperature then re-tempered. Again, such treatments are conventional in the art.

The heat treatment consists of austenitisation at, for example, about 1100° C., followed by an oil or gas quench. Tempering can be double or, if necessary, even triple-tempering or more, with sub-zero treatments in-between the temper steps.

FIGS. 1a and 1b respectively show a phase diagram for a steel alloy with a composition in accordance with Examples 4 and 5 from Table 1. As can be seen, the formation of the δ-ferrite phase is avoided during soaking at 1200° C. FIG. 2 shows a micrograph of a steel alloy with a composition in accordance with Example 1 from Table 1, whereby the alloy was hot-rolled and homogenised. As may be seen, the alloy exhibits a fine grain structure and only small amounts (i.e. <10%) of delta-ferrite (dark grey) are present after homogenisation at 1150° C. for 24 hours. The measured grain size of the delta-ferrite is an average 28 μm, with a standard deviation of 16 μm. The predominant phase is martensite.

As noted above, to avoid excessive austenite grain growth during case-carburising or heat treatment, a small amount of Nb from 0.02-0.06 wt. % is added. Unlike known compositions, the addition of niobium results in the precipitation of niobium-rich precipitates, which are effective in refining austenite grains during high temperature processes. The phase diagrams of FIGS. 1a and 1b show that Nb-rich precipitates are formed.

Furthermore, niobium, in conjunction with the addition of vanadium, facilitates the precipitation of vanadium-rich precipitates which serve the same purpose as niobium-rich precipitates. The phase diagram for the steel alloy of example 5 (FIG. 1b) shows that both Nb-rich and V-rich precipitates are formed. The presence of two different types of precipitates is expected to enhance the austenite grain refinement, thereby resulting in a stronger steel.

In comparison, FIG. 1 c shows a phase diagram for a steel alloy with a composition similar to Pyrowear® 675 stainless, comprising: 13 wt. % Cr; 1.8 wt. % Mo, 0.8 wt. % V, 2.6 wt. % Ni, 5.4 wt. % Co, 0.4 wt. % Si and 0.65 wt. % Mn and Fe. The composition differs from standard Pyrowear® 675 stainless by having a higher vanadium content (the standard composition comprises 0.6 wt. % vanadium). As may be seen, soaking at 1200° C. leads to the formation of some of the undesirable delta-ferrite phase. There is barely any formation of V-rich precipitates.

Steel alloy compositions of the invention also exhibit superior hardness. FIG. 3 shows a graph of the results from a Vickers hardness test according to ISO 6507-1 performed on Samples A and Samples B prepared from stainless steel alloys with a composition according to the invention and on reference samples made from Pyrowear® 675. The composition of the samples was as follows:

| | C | Si | Mn | Mo | Ni | V | Co | Nb |
|---|---|---|---|---|---|---|---|---|
| Samples A | 0.054 | 0.16 | 0.47 | 11.19 | 3.46 | 0.51 | 7.18 | 0.033 |
| Samples B | 0.050 | 0.21 | 0.68 | 11.45 | 1.82 | 1.01 | 8.06 | 0.034 |
| Reference | 0.070 | 0.40 | 0.65 | 13.0 | 2.6 | 0.6 | 5.4 | — |
| Samples | | | | | | | | |

Quantities in wt. %. The balance is iron, together with any unavoidable impurities.

The steel alloys used to prepare all samples were heat-treated in the same manner:
Low-pressure carburization at a temperature of 890-980° C.;
Austenitization at a temperature of 950-1150° C., followed by quenching;
Tempering at a temperature of 450-550° C.;
Sub-zero cooling to a temperature below −120° C.;
Tempering two more times at a temperature of 450-550° C.

In the graph of FIG. 3, the upper line 301 represents the Vickers hardness measured for Samples A; the middle line 302 represents the Vickers hardness measured for Samples B and the lower line 303 represents the Vickers hardness measured for the reference samples. As may be seen, the samples made from stainless alloys of the invention have a higher case hardness than the references samples.

The stainless steel alloys of the invention may be produced by, for example, a double vacuum melting VIM-VAR process, by a VIM-ESR process, by a powder metallurgy (PM) process route, or by spray-forming. Furthermore, if deliberately high nitrogen in the substrate alloy composition is desired, the VIM or P-ESR processes may then be used.

In addition, the core alloy, by virtue of being low in carbon, may also be 3D printed. These are also conventional manufacturing techniques. The Al content is reduced to trace level and preferably kept to a minimum in the PM or the spray-formed alloy variant.

For the VIM-VAR variant, the Al concentration can be in the range of 0.01 to 0.03 wt. %. The N concentration can be in the range of 30 to 60 ppm. Both elements help in pinning austenite grain boundaries in the form of aluminium nitride precipitates, thus ensuring a finer-grained structure that is beneficial for demanding bearing applications.

The forging process of the steel articles is controlled such that the grain sizes are sufficiently fine for the subsequent carburising process not to result in the formation of excessively large grain boundary carbides. For example, the grain sizes may typically range from 30 to 65 μm.

For exceptional resistance to rolling contact fatigue, the case-hardened and tempered bearing components may be followed by surface nitriding or boriding, for example, to further increase the surface hardness of the bearing components. This is particularly applicable to the surface hardness of bearing raceways. Thus, in a preferred embodiment, once a surface of the bearing component has been case-carburised, the surface may be subjected to a surface nitriding treatment to further improve the mechanical properties of the surface layer.

The steel alloy or bearing component may be subjected to a surface finishing technique. For example, burnishing, especially for raceways, followed by, if necessary, tempering and air-cooling. Afterwards, the steel alloy or bearing component may be finished by means of hard-turning and/or finishing operations such as, for example, grinding, lapping and honing.

The burnishing and tempering operations may cause the yield strength of the affected areas to increase with significant improvement in hardness, compressive residual stress and better resistance to rolling contact fatigue.

The foregoing detailed description has been provided by way of explanation and illustration, and is not intended to limit the scope of the appended claims. Many variations in the presently preferred embodiments illustrated herein will be apparent to one of ordinary skill in the art, and remain within the scope of the appended claims and their equivalents.

1. A steel alloy for a bearing, the alloy having a composition comprising:
from 0.04 to 0.1 wt. % carbon,
from 10.5 to 13 wt. % chromium,
from 1.5 to 3.75 wt. % molybdenum,
from 0.3 to 1.2 wt. % vanadium,
from 0.3 to 2.0 wt. % nickel
from 6 to 9 wt. % cobalt,
from 0.05 to 0.4 wt. % silicon,
from 0.2 to 0.8 wt. % manganese,
from 0.02 to 0.06 wt. % niobium,
from 0 to 2.5 wt. % copper,
from 0 to 0.1 wt. % aluminium,
from 0 to 250 ppm nitrogen,
from 0 to 30 ppm boron, and
the balance iron, together with any unavoidable impurities.

2. The steel alloy of claim 1, comprising from 0.05 to 0.09 wt. % carbon.

3. The steel alloy of claim 1, comprising from 10.7 to 12.7 wt. % chromium, more preferably from 11 to 12.5 wt. % chromium.

4. The steel alloy of claim 1, comprising from 1.65 to 3.6 wt. % molybdenum.

5. The steel alloy of claim 1, comprising from 0.4 to 1.1 wt. % vanadium.

6. The steel alloy of claim 1, comprising at least 0.65 wt. % vanadium.

7. The steel alloy of claim 1, comprising from 0.3 to 1.9 wt. % nickel.

8. The steel alloy of claim 1, comprising from 6.5 to 7.7 wt. % cobalt.

9. The steel alloy of claim 1, comprising from 0.05 to 0.3 wt. % silicon.

10. The steel alloy of claim 1, comprising from 0.3 to 0.7 wt. % manganese.

11. The steel alloy of claim 1, comprising from 0.02 to 0.04 wt. % niobium.

12. A bearing component made from the steel alloy of claim 1, wherein a surface of the bearing component is case-carburised and/or carbonitrided.

13. A bearing comprising a bearing component according to claim 12, the bearing component being formed by at least one of an inner ring, an outer ring, or a rolling element of the bearing.

14. The bearing of claim 13, wherein the bearing component is an inner ring and an outer ring, and the bearing further comprises rolling elements made of a ceramic material.

15. The steel alloy of claim 2, comprising from 0.06 to 0.08 wt. % carbon.

16. The steel alloy of claim 15, comprising 0.07 wt. % carbon.

17. The steel alloy of claim 3, comprising from 11 to 12.5 wt. % chromium.

18. The steel alloy of claim 5, comprising from 0.5 to 1.1 wt. % vanadium.
